(19) United States
(12) Patent Application Publication
(10) Pub. No.: US 2012/0137647 A1
(43) Pub. Date: Jun. 7, 2012

(54) END WEIGHTED MOWER BLADE

(76) Inventor: Charles Ernest Daffin, III, Tallahassee, FL (US)

(21) Appl. No.: 13/346,559

(22) Filed: Jan. 9, 2012

Related U.S. Application Data
(63) Continuation-in-part of application No. 12/660,005, filed on Feb. 19, 2010, now abandoned.

(51) Int. Cl. A01D 34/13

(52) U.S. Cl. 56/289

(57) ABSTRACT

A mower blade generally comprised of a rotor which connects to the mower at an attachment point and at least one outer end of the rotor, wherein the outer end or ends of the rotor are heavier than the rotor proximate the attachment point. The added weight to the outer end can be by way of an extension or an end section.

### CROSS-REFERENCES TO RELATED APPLICATIONS

This application is a continuation in part of prior pending application Ser. No. 12/660,005 filed on Feb. 19, 2010.

### STATEMENT REGARDING FEDERALLY SPONSORED RESEARCH OR DEVELOPMENT

Not Applicable

### MICROFICHE APPENDIX

Not Applicable

### BACKGROUND OF THE INVENTION

1. Field of the Invention

This invention relates to the field of mower blades. More specifically, to the weight or mass distribution of the blades center compared to the blades outermost end.

2. Description of the Related Art

When mower blades are new, they provide a clean and quick cut. After repeated uses and wear, the blade starts to loose mass or weight on the outer end. Additionally, repeated sharpening of the blade contributes to the loss of mass on the cutting edge, which is the outermost end of the blade. As the blade end loses mass or weight, it becomes less efficient at cutting and eventually has to be replaced with a new, unworn, blade.

Therefore what is needed is a mower blade that does not lose its cutting efficiency after wear from use and sharpening. And such remedy would also increase the cutting power of the blade. The present invention achieves this objective, as well as others that are explained in the following description.

### BRIEF DESCRIPTION OF THE DRAWINGS

A complete understanding of the present invention may be obtained by reference to the accompanying drawings, when considered in conjunction with the subsequent, detailed description in which:

FIG. 1A is a top plan view of a prior art standard mower blade;

FIG. 1B is a top plan view of a prior art standard mower blade with a worn down prior art cutting edge;

FIG. 2A is a top plan view showing the present invention;

FIG. 2B is a top plan view showing the present invention with a worn down cutting edge worn;

FIG. 3A is a top plan view showing an alternate embodiment of the present invention;

FIG. 3B is a top plan view showing an alternate embodiment of the present invention;

FIG. 4A is a top plan view showing an alternate embodiment of the present invention with an extended outer cutting edge;

FIG. 5A is a top plan view showing an alternate embodiment of the present invention;

FIG. 5B is a top plan view showing an alternate embodiment of the present invention with an extended outer cutting edge;

FIG. 6A is a perspective view of a prior art standard mower blade;

FIG. 6B is a perspective view showing the present invention;

FIG. 6C is a perspective view showing the present invention;

FIG. 7 is a perspective view showing the present invention with added mass to the end section;

FIG. 8 is a cross section view showing the end section attached to the outer cutting edge of the present invention;

FIG. 9A is a perspective view showing the present invention;

FIG. 9B is a cross section view showing the end section attached to the outer cutting edge of the present invention;

REFERENCE NUMERALS IN THE DRAWINGS

| | | | |
|---|---|---|---|
| 10 | present blade | 12 | prior art rotor |
| 14 | prior art center | 16 | extension |
| 18 | end section | 20 | prior art outer cutting edge |
| 26 | inner blade portion | 28 | prior art outer end |
| 30 | outer cutting edge | 32 | rotor |
| 34 | center | 36 | rotor |
| 38 | outer end | 42 | bolts |

### DETAILED DESCRIPTION OF THE INVENTION

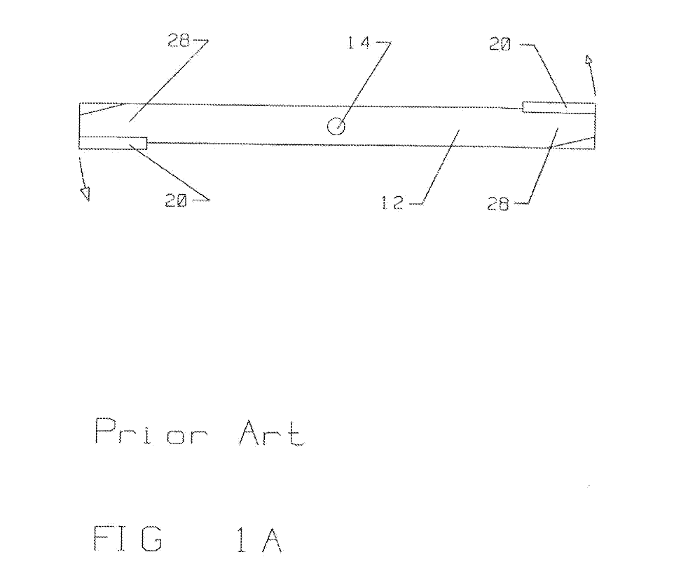

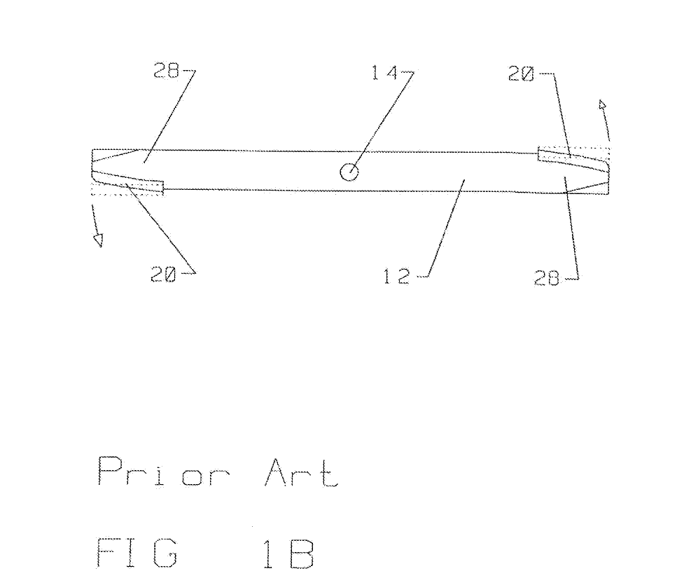

FIG. 1A is a top plan view, showing a prior art standard mower blade. FIG. 1B is also a top plan view showing a prior art standard mower blade with a worn away outer cutting edge. FIGS. 1A and 1B are prior art mower blades showing prior art attachment point 14, prior art rotor 12 and prior art outer cutting edge 20 on prior art outer end 28. In the prior art standard mower blade the prior art rotor 12 has basically the same size throughout. This includes the same thickness and width from prior art attachment point 14 to prior art outer end 28 at prior art outer cutting edge 20. Some blades do have minor shape changes but not enough to be relevant to a substantial increase in mass on prior art outer end 28. As illustrated in FIG. 1B, prior art outer cutting edge 20 is worn down. The wearing away of the prior art cutting edge 20 has reduced the mass on the outer cutting edge 20, causing a significant decrease in cutting potential. Due to the decrease in mass, the energy delivered is now less, which equals less damage to the object being cut. This kind of wear on a standard blade 12 could greatly reduce its cutting efficiency.

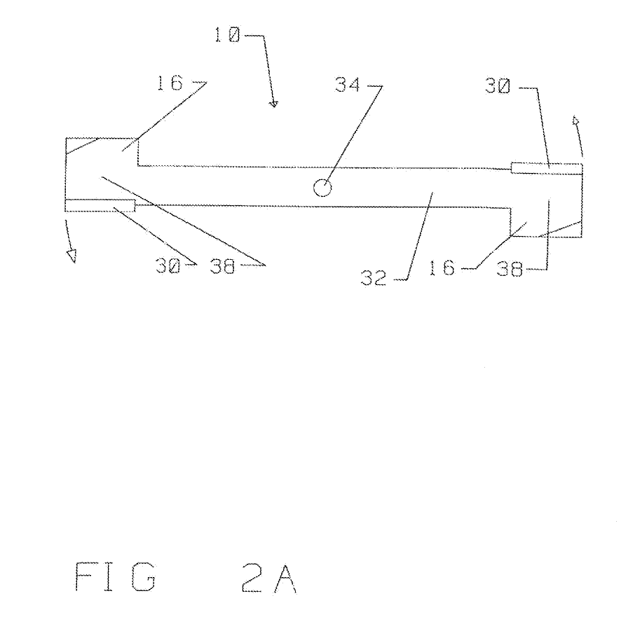

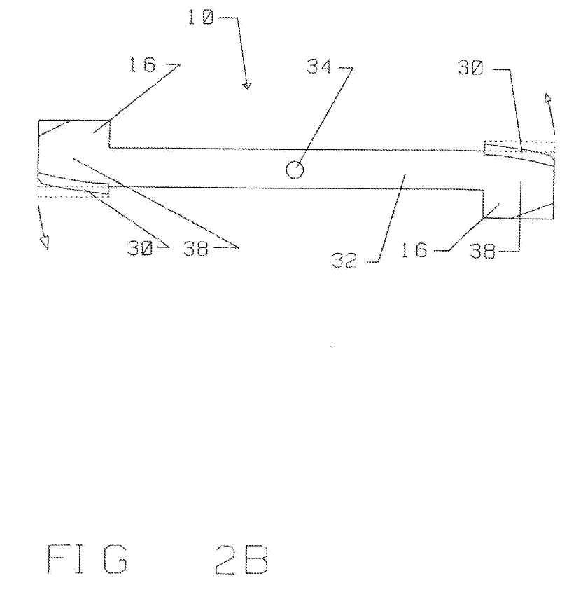

FIG. 2A shows the present invention. The blade 10 generally consists of a rotor with added or increased weight or mass, shown as extension 16 on outer end 38 of rotor 32. The added or increased weight provided by extension 16 generates more energy to the object(s) being cut even where the speed at which the rotor spins remains constant. Extension 16 lies in the same plane as outer end 38, thereby preventing outer end 38 to generate unnecessary drag as it travels through the air. FIG. 2B shows the present invention with a worn down outer cutting edge 30. Outer end 38 with cutting edge 30 has so much more added or increased weight or mass, shown here as extension 16, that the loss from wear is insignificant. Even with the worn away outer cutting edge 30, the present blade will still do damage and will not have to be replaced. Note: the arrows at the outer end 38, show the direction of rotation. Extension 16 extends off of outer end 38 of present blade 10 and remains on the same plane as rotor 32. It is important that the blade remains streamlined such that it does not produce additional drag as it travels through the air.

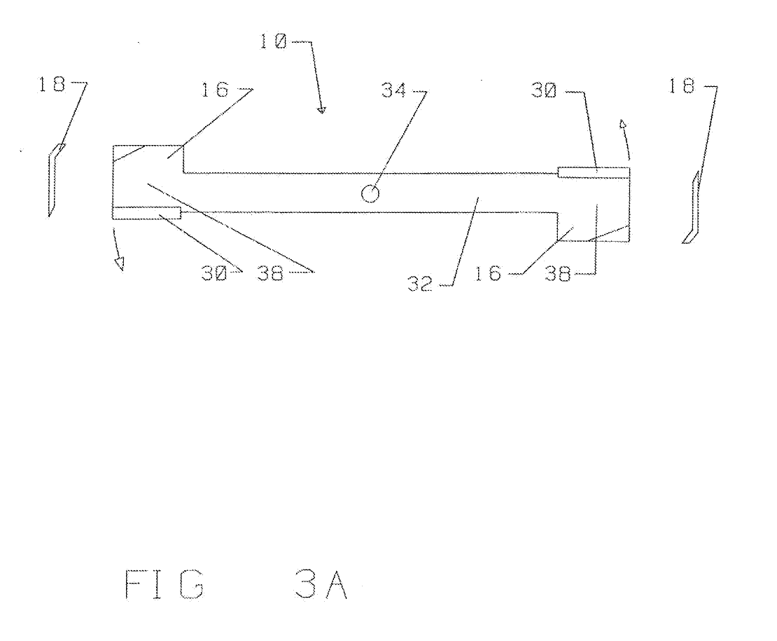

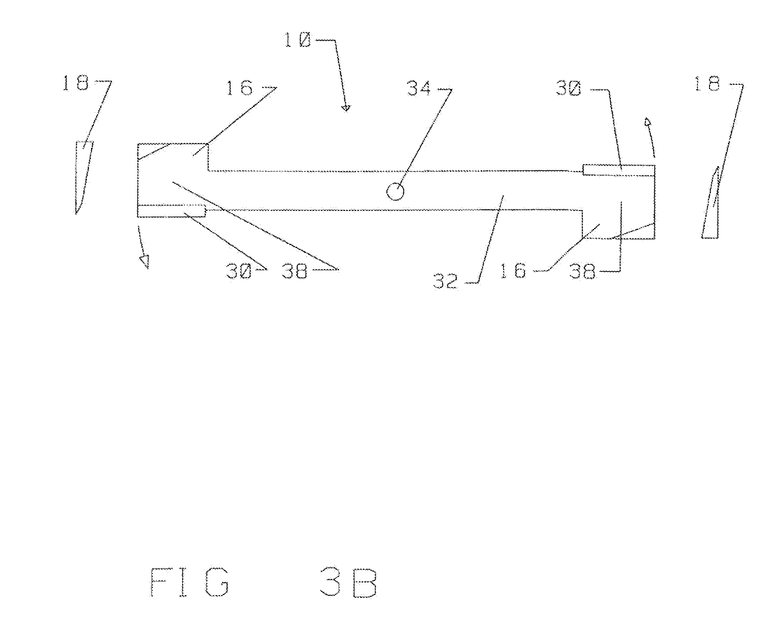

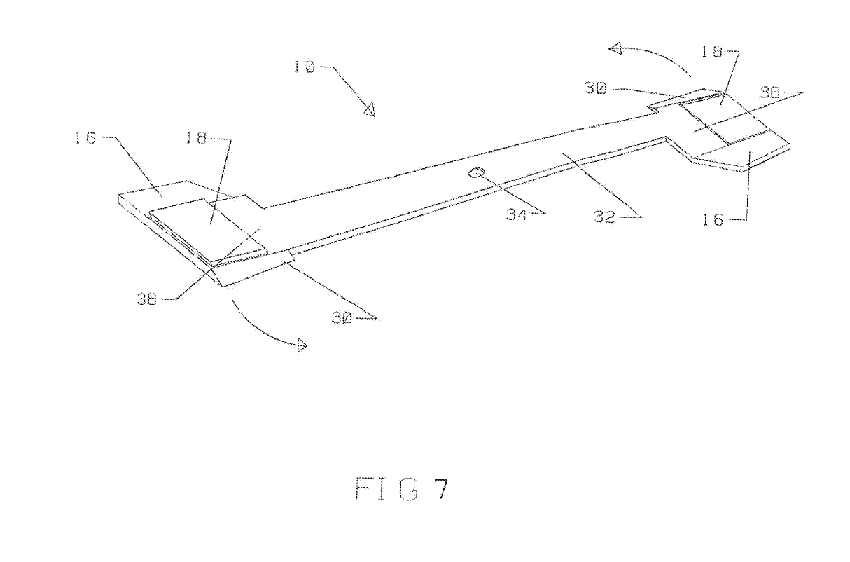

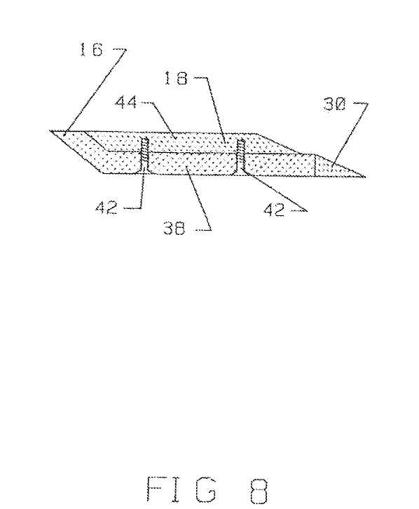

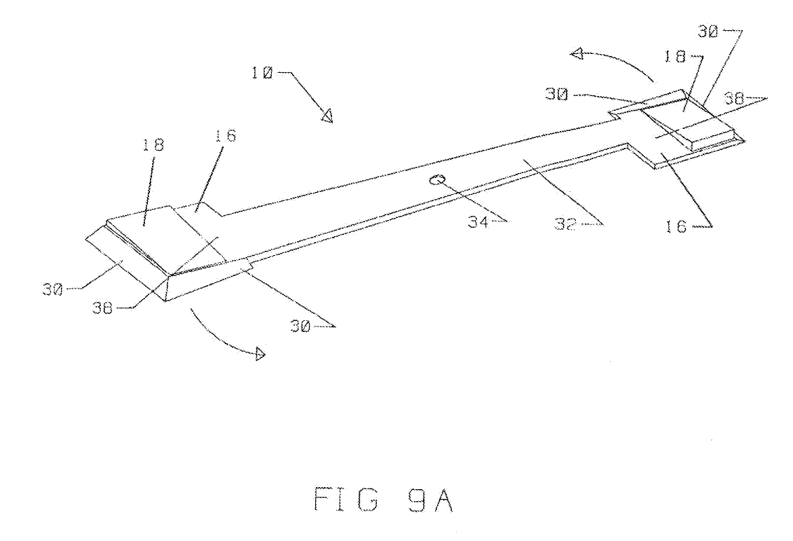

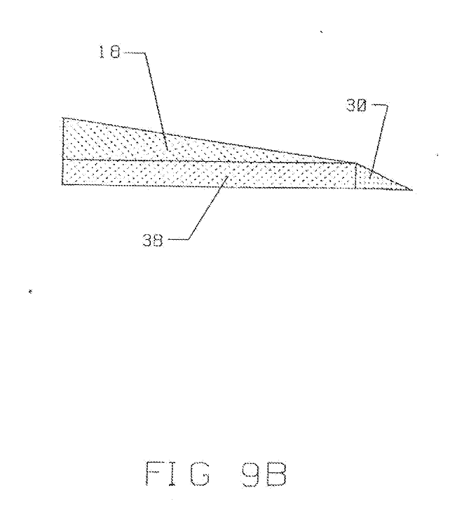

FIGS. 3A and 3B are top plan views of different embodiments of the present invention. In the alternate embodiments there is more mass on the outer end 38 where outer cutting edge 30 is located, and less mass at the “non cutting” attachment point 34. End section 18 is shown on either side of the present blade 10 in both FIG. 3A and 3B. As shown in FIGS. 7 and 9A, end section 18 adds or increases weight further to outer end 38 by either sitting on top of outer end 38 or being integrated fully with outer end 38. A perspective view of end section 18 is shown in FIG. 7 and a cross section view of end section 18 is shown in FIG. 8. As shown in FIG. 7, end section 18 sits on outer end 38 while extension 16 extends off of outer end 38 opposite outer cutting edge 30 and direction of blade (shown by arrows). In FIG. 8 end section 18 is shown bolted to outer end 38 by passing bolts 42 through outer end 38 and into end section 18. While outer end 38 is shown attached in this manner any known method of attaching outer end 38 to the present blade 10 could be used. Additionally, end section 18 could be fully integrated with the present blade 10. FIGS. 9A and 9B illustrate end section 18 set on top outer end 38 while extension 16 does not extend beyond end section 18. Outer cutting edge 30 wraps around outer end 38 to provide an additional cutting edge. In the cross section view shown in FIG. 9B, end section 18 is flush with outer end 38 and can be attached by any known method, including, but not limited to, a glue or weld or end section 18 could be fully integrated with the present blade 10.

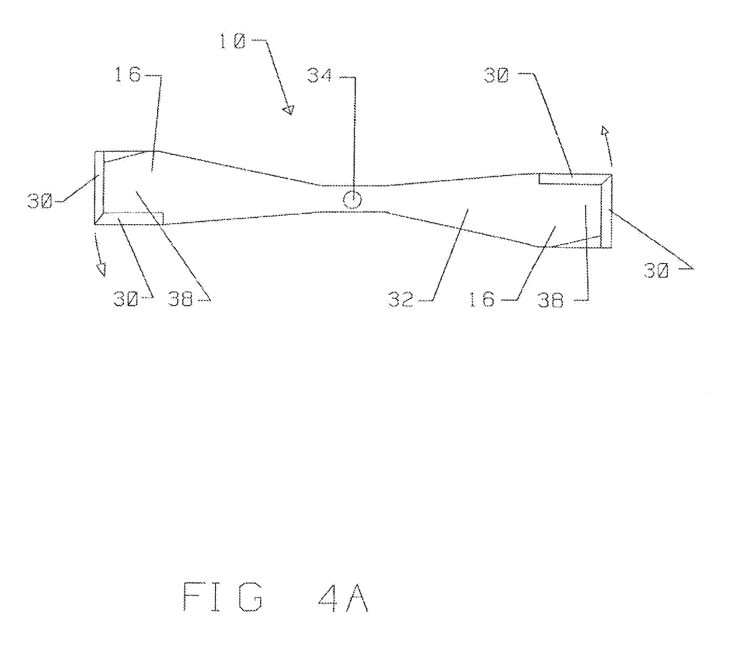

FIG. 4A illustrates the present blade 10 in a slightly different shape which, by design, includes greater weight or mass to the outer end 38 of rotor 32 as opposed to at attachment point 34 of rotor 32. While all of the blades shown are designed as a particular shape, the present invention should not be limited to the shapes shown.

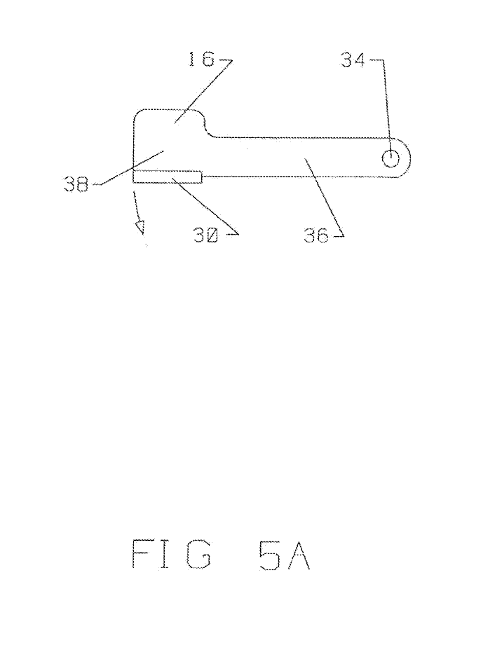

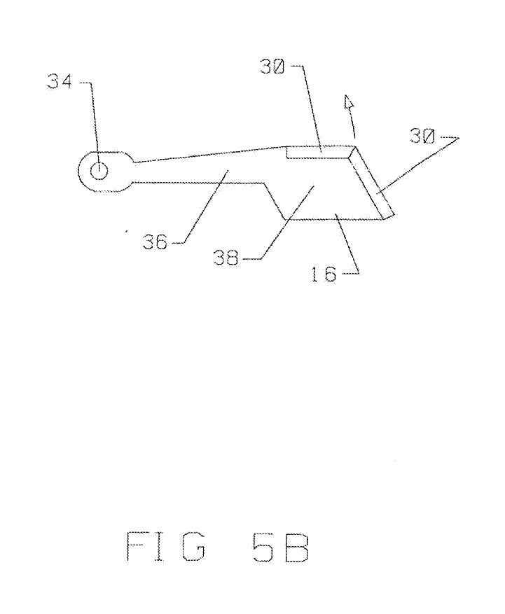

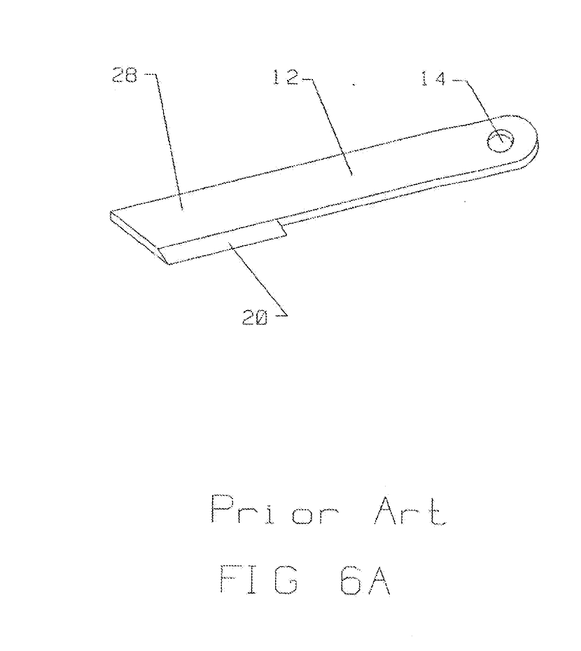

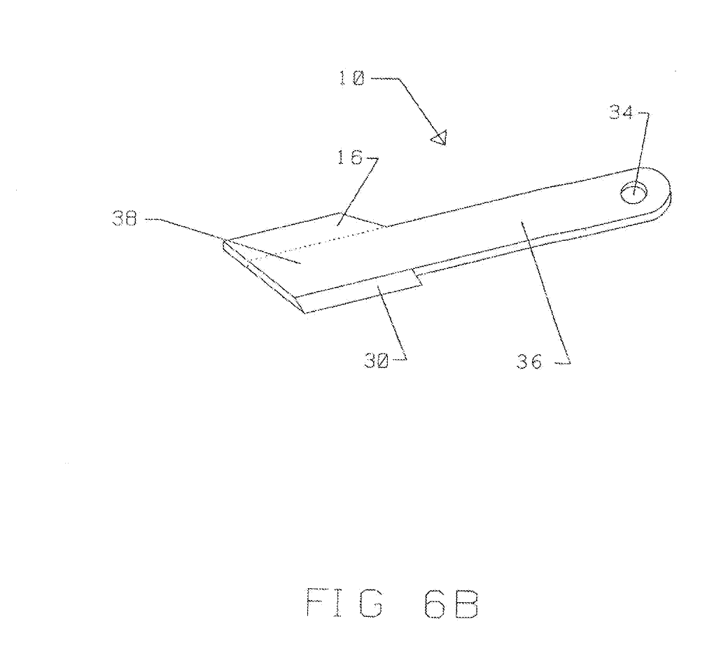

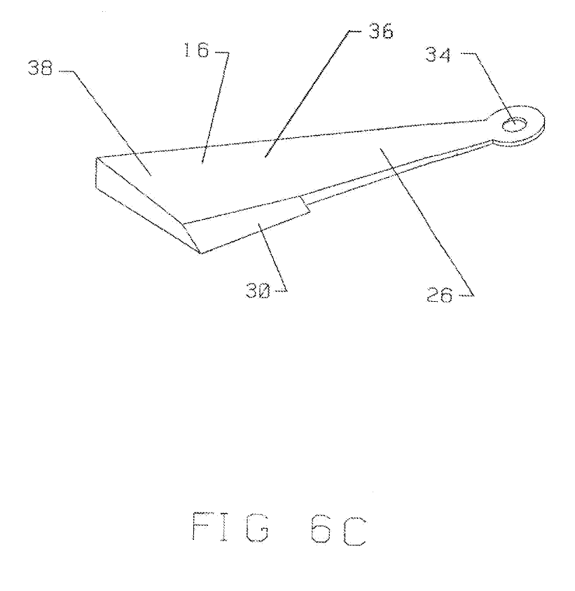

FIGS. 5A and 5B show a top plan view of blades for “bush-hog” type mowers. In FIGS. 5A and 5B extensions 16 are located on outer end 38 for the purpose of adding weight to the outer end 38 of rotor 36. FIG. 6A is a perspective view of a prior art standard blade 12. Standard blade 12 is uniform in weight distribution from prior art attachment point 14 to prior art outer end 28. The present invention, shown in FIG. 6B, creates more mass on outer end 38 by increasing blade width with the addition of extension 16 which lies in the same plane as rotor 36. The present invention is also shown in 6C, wherein the desired result is achieved by increasing the width of outer end 38 in comparison to the smaller blade portion 26 as it nears, attachment point 34. The additional weight, shown by extension 16 or by increasing the width of rotor 36 at outer end 38, increases the energy to be delivered by outer cutting edge 30 upon an external object, such as grass.

Since other modifications and changes varied to fit particular operating requirements and environments will be apparent to those skilled in the art, the invention is not considered limited to the example chose for purposes of disclosure, and covers all changes and modifications which do not constitute departures from the scope of this invention.

1. A mower blade, comprising:
a. a rotor which connects to said mower at an attachment point, said rotor lying within a plane and having a direction of rotation;
b. at least one outer end of said rotor, said at least one outer end of said rotor having a direction of travel corresponding to said direction of rotation of said rotor;
c. wherein said at least one outer end further comprises:
i. a cutting edge lying within said plane of said rotor, said cutting edge facing said direction of travel for said at least one outer end,
ii. a trailing edge lying within said plane of said rotor, said trailing edge facing opposite said direction of travel for said at least one outer end,
iii. an extension extending from said trailing edge in a direction opposite said direction of travel for said at least one outer end, said extension lying within said plane of said rotor;
d. wherein said extension substantially increases a mass of said at least one outer end in comparison to a mass of a remainder of said rotor.

2. The mower blade of claim 1, wherein said at least one outer end of said rotor has a width that is greater than said width of said rotor at said attachment point.

3. The mower blade of claim 1, wherein said at least one outer end of said rotor has a weight that is greater than said weight of said rotor at said attachment point.

4. The mower blade of claim 2, wherein an end section is attached to said extension at said at least one outer end of said rotor.

5. A mower blade, comprising:
a. a rotor having an attachment point a direction of rotation and at least two outer ends, said rotor lying within a plane;
b. wherein said rotor connects to said mower at said attachment point;
c. wherein said rotor proximate said attachment point weighs less than said rotor proximate said outer ends of said rotor;
d. wherein at least one of said outer ends further comprises:
i. a cutting edge lying within said plane of said rotor, said cutting edge facing said direction of travel for said at least one outer end,
ii. a trailing edge lying within said plane of said rotor, said trailing edge facing opposite said direction of travel for said at least one outer end,
iii. an extension extending from said trailing edge in a direction opposite said direction of travel for said at least one outer end, said extension lying within said plane of said rotor; and
e. wherein said extension substantially increases a mass of said at least one outer end in comparison to a mass of a remainder of said rotor.

6. The mower blade of claim 5, further comprising a second outer cutting edge angularly displaced from said first outer cutting edge.

7. A mower blade, comprising:
a. a rotor connected to said mower at an attachment point, wherein said rotor proximate said attachment point has a first weight;
b. at least one outer end of said rotor having a second weight;
c. wherein said second weight is greater than said first weight;
d. wherein said rotor lies within a plane and has a direction of rotation, with said at least one outer end having a direction of travel corresponding to said direction of rotation of said rotor;
e. wherein said at least one outer end further comprises,
i. a cutting edge lying within said plane of said rotor, said cutting edge facing said direction of travel for said at least one outer end,
ii. a trailing edge lying within said plane of said rotor, said trailing edge facing opposite said direction of travel for said at least one outer end,
iii. an extension extending from said trailing edge in a direction opposite said direction of travel for said at least one outer end, sad extension lying within said plane of said rotor; and
f. wherein said extension substantially increases a mass of said at least one outer end in comparison to a mass of a remainder of said rotor.

8. The mower blade of claim 7, wherein said second weight is comprised of a heavier metal than said rotor proximate said attachment point.
